(19) United States
(12) Patent Application Publication
(10) Pub. No.: US 2017/0355562 A1
(43) Pub. Date: Dec. 14, 2017

(54) FIRE SERVICE SEQUENCE FOR MULTICAR ELEVATOR SYSTEMS

(71) Applicant: Otis Elevator Company, Farmington, CT (US)

(72) Inventors: Jose Miguel Pasini, Avon, CT (US); Arthur Hsu, South Glastonbury, CT (US); David Ginsberg, Granby, CT (US)

(21) Appl. No.: 15/179,621

(22) Filed: Jun. 10, 2016

(51) Int. Cl. B66B 5/02; B66B 9/00; B66B 1/28

(52) U.S. Cl. CPC B66B 5/024; B66B 5/027; B66B 1/28; B66B 9/003

(57) ABSTRACT

A method of operating a multi-car elevator system for a fire service sequence including the steps of: controlling, using a control system, a plurality of components of the multi-car elevator system, the controlling includes operating at least one of a first elevator car and a second elevator in at least one elevator lane; confirming the first elevator car is free of occupants; moving the first elevator car to a parking area; and confirming the second elevator car is free of occupants.

### BACKGROUND

The subject matter disclosed herein generally relates to the field of elevators, and more particularly to a fire service sequence of a multicar, ropeless elevator system.

Ropeless elevator systems, also referred to as self-propelled elevator systems, are useful in certain applications (e.g., high rise buildings) where there is a desire for multiple elevator cars to travel in a single hoistway, elevator shaft, or lane. In some ropeless elevator systems in which a first lane is designated for upward traveling elevator cars and a second lane is designated for downward traveling elevator cars. A transfer station at each end of the lane is typically used to move cars horizontally between the first lane and second lane. Additional transfer stations at intermediate locations may or may not be included.

### BRIEF SUMMARY

According to one embodiment, a method of operating a multi-car elevator system for a fire service sequence is provided. The method including the steps of: controlling, using a control system, a plurality of components of the multi-car elevator system, the controlling includes operating at least one of a first elevator car and a second elevator in at least one elevator lane; confirming the first elevator car is free of occupants; moving the first elevator car to a parking area; and confirming the second elevator car is free of occupants.

In addition to one or more of the features described above, or as an alternative, further embodiments of the method may include: moving, using the control system, the second elevator car to the parking area.

In addition to one or more of the features described above, or as an alternative, further embodiments of the method may include that the multi-car elevator system is a ropeless elevator system.

In addition to one or more of the features described above, or as an alternative, further embodiments of the method may include that the parking area is a designated parking area, the designated parking area being operably connected to the at least one elevator lane.

In addition to one or more of the features described above, or as an alternative, further embodiments of the method may include the multi-car elevator system includes at least two elevator lanes.

In addition to one or more of the features described above, or as an alternative, further embodiments of the method may include that the parking area is located within one of the at least two elevator lanes.

In addition to one or more of the features described above, or as an alternative, further embodiments of the method may include confirming further includes: detecting, using a plurality of sensors, whether an occupant is present in an elevator.

According to another embodiment, a multi-car elevator system is provided. The system including: a processor; and a memory including computer-executable instructions that, when executed by the processor, cause the processor to perform operations. The operations including the steps of: controlling a plurality of components of the multi-car elevator system, the controlling includes operating at least one of a first elevator car and a second elevator in at least one elevator lane; confirming the first elevator car is free of occupants; moving the first elevator car to a parking area; and confirming the second elevator car is free of occupants.

In addition to one or more of the features described above, or as an alternative, further embodiments of the system may include that the operations further include: moving the second elevator car to the parking area.

In addition to one or more of the features described above, or as an alternative, further embodiments of the system may include that the multi-car elevator system is a ropeless elevator system.

In addition to one or more of the features described above, or as an alternative, further embodiments of the system may include that the parking area is a designated parking area, the designated parking area being operably connected to the at least one elevator lane.

In addition to one or more of the features described above, or as an alternative, further embodiments of the system may include that the multi-car elevator system includes at least two elevator lanes.

In addition to one or more of the features described above, or as an alternative, further embodiments of the system may include that the parking area is located within one of the at least two elevator lanes.

In addition to one or more of the features described above, or as an alternative, further embodiments of the system may include that confirming further include: detecting, using a plurality of sensors, whether an occupant is present in an elevator.

According to another embodiment, a computer program product tangibly embodied on a computer readable medium is provided. The computer program product including instructions that, when executed by a processor, cause the processor to perform operations: The operations including the steps of: controlling a plurality of components of a multi-car elevator system, the controlling includes operating at least one of a first elevator car and a second elevator in at least one elevator lane; confirming the first elevator car is free of occupants; moving the first elevator car to a parking area; and confirming the second elevator car is free of occupants.

In addition to one or more of the features described above, or as an alternative, further embodiments of the computer may include that the operations further include: moving the second elevator car to the parking area.

In addition to one or more of the features described above, or as an alternative, further embodiments of the computer program may include that the multi-car elevator system is a ropeless elevator system.

In addition to one or more of the features described above, or as an alternative, further embodiments of the computer program may include that the parking area is a designated parking area, the designated parking area being operably connected to the at least one elevator lane.

In addition to one or more of the features described above, or as an alternative, further embodiments of the computer program may include that the multi-car elevator system includes at least two elevator lanes.

In addition to one or more of the features described above, or as an alternative, further embodiments of the computer program may include that the parking area is located within one of the at least two elevator lanes.

Technical effects of embodiments of the present disclosure include a fire service sequence for ensuring proper evacuation of occupants within a multicar elevator system.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The foregoing and other features, and advantages of the disclosure are apparent from the following detailed description taken in conjunction with the accompanying drawings in which like elements are numbered alike in the several FIGURES:

FIG. 1 illustrates a schematic view of an exemplary multicar elevator system, in accordance with an embodiment of the disclosure;

FIG. 2 illustrates an enlarged schematic view of an exemplary single elevator car within the multicar elevator system of FIG. 1, in accordance with an embodiment of the disclosure; and

FIG. 3 is a flow diagram illustrating an exemplary method of operating the multi-car elevator system of FIG. 1 for a fire service sequence, according to an embodiment of the present disclosure.

### DETAILED DESCRIPTION

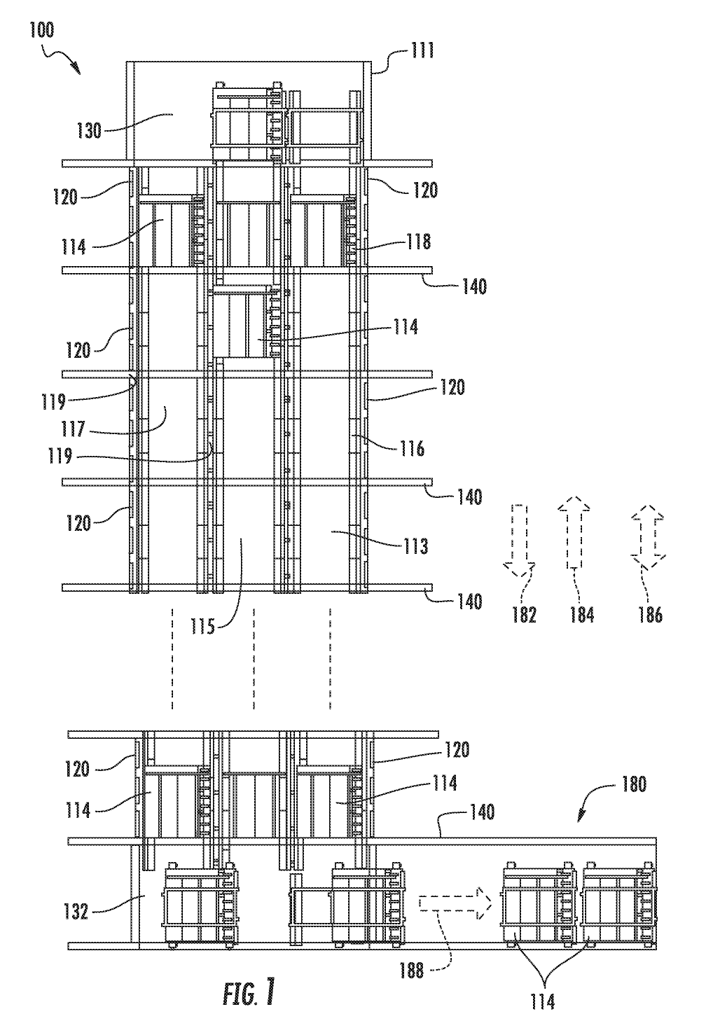

FIG. 1 depicts an exemplary multicar, ropeless elevator system 100 that may be employed with embodiments of the present disclosure. Elevator system 100 includes an elevator shaft 111 having a plurality of lanes 113, 115 and 117. While three lanes 113, 115, 117 are shown in FIG. 1, it is understood that various embodiments of the present disclosure and various configurations of a multicar, ropeless elevator system may include any number of lanes, either more or fewer than the three lanes shown in FIG. 1. In each lane 113, 115, 117, multiple elevator cars 114 can travel in one direction, i.e., up as shown by arrow 184 or down as shown by arrow 182, or multiple cars within a single lane may be configured to move in opposite directions, as shown by arrow 186. For example, in FIG. 1 elevator cars 114 in lanes 113 and 115 travel up in the direction of arrow 184 and elevator cars 114 in lane 117 travel down in the direction of arrow 182. Further, as shown in FIG. 1, one or more elevator cars 114 may travel in a single lane 113, 115, and 117.

As shown, above the top accessible floor of the building is an upper transfer station 130 configured to impart horizontal motion to the elevator cars 114 to move the elevator cars 114 between lanes 113, 115, and 117. It is understood that upper transfer station 130 may be located at the top floor, rather than above the top floor. Similarly, below the first floor of the building is a lower transfer station 132 configured to impart horizontal motion to the elevator cars 114 to move the elevator cars 114 between lanes 113, 115, and 117. It is understood that lower transfer station 132 may be located on the first floor, rather than below the first floor. Although not shown in FIG. 1, one or more intermediate transfer stations may be configured between the lower transfer station 132 and the upper transfer station 130. Intermediate transfer stations are similar to the upper transfer station 130 and lower transfer station 132 and are configured to impart horizontal motion to the elevator cars 114 at the respective transfer station, thus enabling transfer from one lane to another lane at an intermediary point within the elevator shaft 111. Further, although not shown in FIG. 1, the elevator cars 114 are configured to stop at a plurality of floors 140 to allow ingress to and egress from the elevator cars 114.

In the illustrated embodiment the elevator system 100 includes a designated parking area 180. The designated parking area 180 may be used to store elevator cars 114 either when not in use or during a fire service sequence. As shown in FIG. 1, the designated parking area 180 may be located below the first floor of the building, however it is understood that the designated parking area 180 may be located on any other floor of the building or also above the top floor of the building. If an elevator system 100 does not include a designated parking area 180 then one of the lanes 113, 115, or 117 may be shut off to elevator car traffic and used to store the elevators cars 114.

Elevator cars 114 are propelled within lanes 113, 115, 117 using a propulsion system such as a linear, permanent magnet motor system having a primary, fixed portion, or first part 116, and a secondary, moving portion, or second part 118. The first part 116 is a fixed part because it is mounted to a portion of the lane, and the second part 118 is a moving part because it is mounted on the elevator car 114 that is movable within the lane.

The first part 116 includes windings or coils mounted on a structural member 119, and may be mounted at one or both sides of the lanes 113, 115, and 117, relative to the elevator cars 114.

The second part 118 includes permanent magnets mounted to one or both sides of cars 114, i.e., on the same sides as the first part 116. The second part 118 engages with the first part 116 to support and drive the elevators cars 114 within the lanes 113, 115, 117. First part 116 is supplied with drive signals from one or more drive units 120 to control movement of elevator cars 114 in their respective lanes through the linear, permanent magnet motor system. The second part 118 operably connects with and electromagnetically operates with the first part 116 to be driven by the signals and electrical power. The driven second part 118 enables the elevator cars 114 to move along the first part 116 and thus move within a lane 113, 115, and 117.

Those of skill in the art will appreciate that the first part 116 and second part 118 are not limited to this example. In alternative embodiments, the first part 116 may be configured as permanent magnets, and the second part 118 may be configured as windings or coils. Further, those of skill in the art will appreciate that other types of propulsion may be used without departing from the scope of the present disclosure.

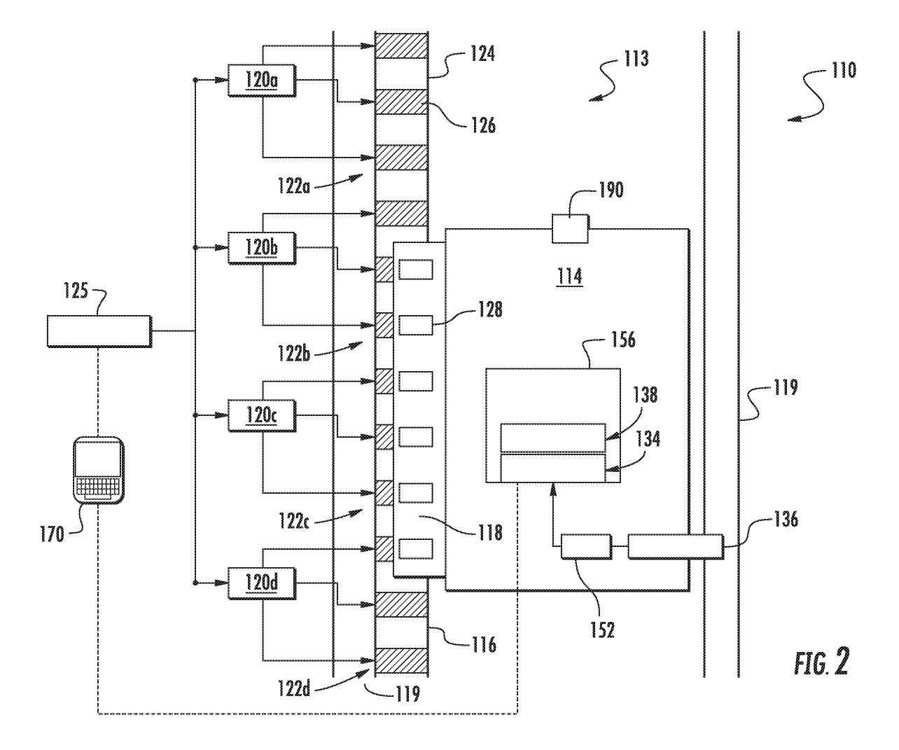

The first part 116, as shown in FIG. 1, is formed from a plurality of motor segments 122 (seen in FIG. 2), with each segment associated with a drive unit 120. Although not shown, the central lane 115 of FIG. 1 also includes a drive unit for each segment of the first part 116 that is within the lane 115. Those of skill in the art will appreciate that although a drive unit 120 is provided for each motor segment 122 (seen in FIG. 2) of the system (one-to-one) other configurations may be used without departing from the scope of the present disclosure. Further, those of skill in the art will appreciate that other types of propulsion may be employed without departing from the scope of the present disclosure. For example, a magnetic screw may be used for a propulsion system of elevator cars. Thus, the described and shown propulsion system of this disclosure is merely provided for explanatory purposes, and is not intended to be limiting.

Turning now to FIG. 2, a view of an exemplary elevator system 110 including an elevator car 114 that travels in lane 113 is shown. Elevator car 114 is guided by one or more guide rails 124 extending along the length of lane 113, where the guide rails 124 may be affixed to a structural member 119. For ease of illustration, the view of FIG. 2 only depicts a single guide rail 124; however, there may be any number of guide rails positioned within the lane 113 and may, for example, be positioned on opposite sides of the elevator car 114. Elevator system 110 employs a linear propulsion system as described above, where a first part 116 includes multiple motor segments 122a, 122b, 122c, 122d each with one or more coils 126 (i.e., phase windings). The first part 116 may be mounted to guide rail 124, incorporated into the guide rail 124, or may be located apart from guide rail 124 on structural member 119. The first part 116 serves as a stator of a permanent magnet synchronous linear motor to impart force to elevator car 114. The second part 118, as shown in FIG. 2, is mounted to the elevator car 114 and includes an array of one or more permanent magnets 128 to form a second portion of the linear propulsion system of the ropeless elevator system. Coils 126 of motor segments 122a, 122b, 122c, 122d may be arranged in one or more phases, as is known in the electric motor art, e.g., three, six, etc. One or more first parts 116 may be mounted in the lane 113, to co-act with permanent magnets 128 mounted to elevator car 114. Although only a single side of elevator car 114 is shown with permanent magnets 128 the example of FIG. 2, the permanent magnets 128 may be positioned on two or more sides of elevator car 114. Alternate embodiments may use a single first part 116/second part 118 configuration, or multiple first part 116/second part 118 configurations.

In the example of FIG. 2, there are four motor segments 122a, 122b, 122c, 122d depicted. Each of the motor segments 122a, 122b, 122c, 122d has a corresponding or associated drive 120a, 120b, 120c, 120d. A system controller 125 provides drive signals to the motor segments 122a, 122b, 122c, 122d via drives 120a, 120b, 120c, 120d to control motion of the elevator car 114. The system controller 125 may be implemented using a microprocessor executing a computer program stored on a storage medium to perform the operations described herein. Alternatively, the system controller 125 may be implemented in hardware (e.g., ASIC, FPGA) or in a combination of hardware/software. The system controller 125 may also be part of an elevator control system. The system controller 125 may include power circuitry (e.g., an inverter or drive) to power the first part 116. Although a single system controller 125 is depicted, it will be understood by those of ordinary skill in the art that a plurality of system controllers may be used. For example, a single system controller may be provided to control the operation of a group of motor segments over a relatively short distance, and in some embodiments a single system controller may be provided for each drive unit or group of drive units, with the system controllers in communication with each other.

In some embodiments, as shown in FIG. 2, the elevator car 114 includes an on-board controller 156 with one or more transceivers 138 and a processor, or CPU, 134. The on-board controller 156 and the system controller 125 collectively form a control system where computational processing may be shifted between the on-board controller 156 and the system controller 125.

The controller system may include at least one processor and at least one associated memory comprising computer-executable instructions that, when executed by the processor, cause the processor to perform various operations. The processor may be but is not limited to a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory may be a storage device such as, for example, a random access memory (RAM), read only memory (ROM), or other electronic, optical, magnetic or any other computer readable medium.

In some embodiments, the processor 134 of on-board controller 156 is configured to monitor one or more sensors and to communicate with one or more system controllers 125 via the transceivers 138. In some embodiments, to ensure reliable communication, elevator car 114 may include at least two transceivers 138 configured for redundancy of communication. The transceivers 138 can be set to operate at different frequencies, or communication channels, to minimize interference and to provide full duplex communication between the elevator car 114 and the one or more system controllers 125. In the example of FIG. 2, the on-board controller 156 interfaces with a load sensor 152 to detect an elevator load on a brake 136. The brake 136 may engage with the structural member 119, a guide rail 124, or other structure in the lane 113. Although the example of FIG. 2 depicts only a single load sensor 152 and brake 136, elevator car 114 can include multiple load sensors 152 and brakes 136.

In an embodiment, the ropeless elevator system 100 may include a command input device 170 operably connected to the control system (controller 125 and on-board controller 156). The command input device 170 allows an operator to input commands to control the elevators cars 114 of the ropeless elevator system 100. For example, during an evacuation, rescue personnel may need to take command of the ropeless elevator system 100 to initiate a fire service sequence to ensure that all occupants of the ropeless elevator system 100 have been safely removed. The data input device 170 may be an interface device such as, for example, an elevator operational panel, an elevator recall control panel, an elevator supervisory panel, a cellular phone, tablet, laptop, smartwatch, desktop computer or any similar device known to one of skill in the art. The data input device 170 may be operably connected to the control system via a hard wire or wirelessly through a wireless transmission method such as, for example, radio, microwave, cellular, satellite, or another wireless communication method.

In a non-limiting embodiment, the control system may verify that no occupants are present in the elevator car 114 by utilizing a plurality of sensors 190. The plurality of sensors may include but are not limited to infrared, heat, sonar, echolocation, acoustic, motion, weight, pressure, video or a similar sensing device known to one of skill in the art. For instance, the plurality of sensors 190 may include a video camera where the rescue personnel may be able to view the interior of the elevator car 114 to check for occupants.

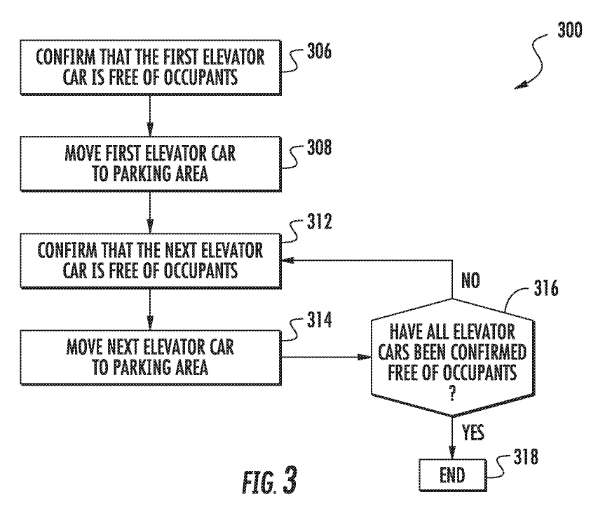

Turning now to FIG. 3, which shows a flow diagram illustrating an exemplary method 300 of operating the multi-car elevator system of FIG. 1 for a fire service sequence, according to an embodiment of the present disclosure. Rescue personnel may initiate method 300 using the command input device 170 of FIG. 2. Rescue personnel may include firefighter, building operators, policeman, paramedics or any other similar rescue personnel. First at block 306, a first elevator car is confirmed free of occupants after it has been checked for occupants. In order for the first car to be checked, the control system may move the first elevator car to a recall floor. The recall floor is a selected floor where rescue personnel may check the elevator car during the fire service sequence. The first elevator car may also be checked by a plurality of sensors, such as, for example a video camera where rescue personnel could visually see inside the car and/or detect occupants. As may be appreciated by one of skill in the art, the recall floor (i.e. selected floor) may be any floor within the building. In a non-limiting embodiment, the recall floor may be the bottom floor, or ground floor, of a building. The recall floor may be a pre-set floor or it may be a floor determined by the control system and/or the rescue personnel at the time of recall. For instance, in a non-limiting embodiment, the recall floor may be the floor where the rescue personnel initiate the fire service sequence of method 300, as determined by the control system. In another non-limiting embodiment, the recall floor may be manually entered by the rescue personnel. Also, in a non-limiting embodiment, the first elevator car may be an elevator car nearest to the recall floor at the time the fire service sequence of method 300 is initiated. If the elevator car is equipped with a plurality of sensors through which the rescue personnel may check the car, the control system may not need to move the elevator car to a recall floor. For instance, the elevator car may have a video camera through which the rescue personnel may check the elevator car for passengers.

The control system may open the doors of the first elevator and allow rescue personnel to check the elevator car for occupants when the first car is at the recall floor. In a non-limiting embodiment, the control system may confirm that no occupants are present in the elevator car utilizing a plurality of sensors. In a non-limiting embodiment, the plurality of sensors may be operably connected to the control system. For instance, the first elevator car is confirmed empty by the plurality of sensors and a confirmation is sent by the plurality of sensors to the control system. In another non-limiting embodiment, the plurality of sensors may be separate from the control system. For instance, the plurality of sensors may include a video camera, from which rescue personnel may view the car and then send a confirmation to the control system. Thus, the rescue personnel and/or the plurality of sensors will send a command input to the control system, confirming the first elevator car is empty.

Once the first car is checked for occupants and it is confirmed that no occupants are present, at block 308 the control system will close the doors of the first elevator car and then move the first elevator car to a parking area as shown by arrow 188 in FIG. 1. In a non-limiting embodiment, the parking area may be a designated parking area that is not within a lane of an elevator but is operably connected to the elevator lane(s). As shown in FIG. 1, the designated parking area 180 may be perpendicular to the elevator lane(s). In another non-limiting embodiment, the parking area may be located perpendicular to the elevator lane(s) on any floor of the building. Further, in another non-limiting embodiment, the parking area may be located parallel to the elevator lane(s) above the top floor of the building and/or below the bottom floor of the building. Moreover, in another non-limiting embodiment, the parking area may be an elevator lane itself. In a first example, the recall floor may be any middle floor (i.e. not the top or the bottom floor) within the building and the parking area may be above and/or below that middle floor. In a second example, in a multi-lane elevator system having at least two elevator lanes, one of the elevator lanes may be used as a parking area.

Next at block 312, it is confirmed that the next elevator car is free of occupants after the next elevator has been checked for occupants. In order to check the elevator car for occupants, the control system may move the second car (i.e. next car) to the recall floor so that rescue personnel may check the car. As mentioned above, if the elevator car is equipped with a plurality of sensors through which the rescue personnel may check the car, the control system may not need to move the elevator car to a recall floor. For instance, the elevator car may have a video camera through which the rescue personnel may check the elevator car for passengers. The process for checking the second elevator car is similar to the process for checking the first elevator car, described above. Once the second car is checked for occupants and it is confirmed that no occupants are present, at block 314 the control system will close the doors of the second elevator car and then move the second elevator car to the parking area. The control system will then confirm that all elevator cars have been confirmed free of occupants. If all elevator cars have not been checked, the method 300 will then return to block 312 to confirm that the next elevator car is free of occupants and the process may be repeated until all elevator cars have been confirmed free of occupants. Once all elevator cars have been confirmed free of occupants, the method ends at block 318, at which time the rescue personnel are free to make use of one or more of the elevator cars as they desire.

The terminology used herein is for the purpose of describing particular embodiments only and is not intended to be limiting. While the description has been presented for purposes of illustration and description, it is not intended to be exhaustive or limited to embodiments in the form disclosed. Many modifications, variations, alterations, substitutions or equivalent arrangement not hereto described will be apparent to those of ordinary skill in the art without departing from the scope of the disclosure. Additionally, while the various embodiments have been described, it is to be understood that aspects may include only some of the described embodiments. Accordingly, the disclosure is not to be seen as limited by the foregoing description, but is only limited by the scope of the appended claims.

1. A method of operating a multi-car elevator system for a fire service sequence, the method comprising:
controlling, using a control system, a plurality of components of the multi-car elevator system, wherein controlling comprises operating at least one of a first elevator car and a second elevator in at least one elevator lane;
confirming the first elevator car is free of occupants prior to moving the first elevator car to a parking area;
moving the first elevator car to the parking area; and
confirming the second elevator car is free of occupants prior to moving the second elevator car to the parking area.

2. The method of claim 1, further comprising:
moving, using the control system, the second elevator car to the parking area.

3. The method of claim 1, wherein:
the multi-car elevator system is a ropeless elevator system.

4. The method of claim 1, wherein:
the parking area is a designated parking area, the designated parking area being operably connected to the at least one elevator lane, wherein the designated parking area is not within an elevator lane.

5. The method of claim 1, wherein:
the multi-car elevator system includes at least two elevator lanes.

6. The method of claim 5, wherein:
the parking area is located within one of the at least two elevator lanes.

7. The method of claim 1, wherein confirming further comprises:
detecting, using a plurality of sensors, whether an occupant is present in an elevator.

8. A multi-car elevator system comprising:
a processor;
a memory comprising computer-executable instructions that, when executed by the processor, cause the processor to perform operations, the operations comprising:
controlling a plurality of components of the multi-car elevator system, wherein controlling comprises operating at least one of a first elevator car and a second elevator in at least one elevator lane;
confirming the first elevator car is free of occupants prior to moving the first elevator car to a parking area;
moving the first elevator car to the parking area; and
confirming the second elevator car is free of occupants prior to moving the second elevator car to the parking area.

9. The multi-car elevator system of claim 8, wherein the operations further comprise:
moving the second elevator car to the parking area.

10. The multi-car elevator system of claim 8, wherein:
the multi-car elevator system is a ropeless elevator system.

11. The multi-car elevator system of claim 8, wherein:
the parking area is a designated parking area, the designated parking area being operably connected to the at least one elevator lane, wherein the designated parking area is not within an elevator lane.

12. The multi-car elevator system of claim 8, wherein:
the multi-car elevator system includes at least two elevator lanes.

13. The multi-car elevator system of claim 12, wherein:
the parking area is located within one of the at least two elevator lanes.

14. The multi-car elevator system of claim 8, wherein confirming further comprises:
detecting, using a plurality of sensors, whether an occupant is present in an elevator.

15. A computer program product tangibly embodied on a computer readable medium, the computer program product including instructions that, when executed by a processor, cause the processor to perform operations comprising:
controlling a plurality of components of a multi-car elevator system, wherein controlling comprises operating at least one of a first elevator car and a second elevator in at least one elevator lane;
confirming the first elevator car is free of occupants prior to moving the first elevator car to a parking area;
moving the first elevator car to the parking area; and
confirming the second elevator car is free of occupants prior to moving the second elevator car to the parking area.

16. The computer program of claim 15, wherein the operations further comprise:
moving the second elevator car to the parking area.

17. The computer program of claim 15, wherein:
the multi-car elevator system is a ropeless elevator system.

18. The computer program of claim 15, wherein:
the parking area is a designated parking area, the designated parking area being operably connected to the at least one elevator lane, wherein the designated parking area is not within an elevator lane.

19. The computer program of claim 15, wherein:
the multi-car elevator system includes at least two elevator lanes.

20. The computer program of claim 19, wherein:
the parking area is located within one of the at least two elevator lanes.
